(19) United States
(12) Patent Application Publication
(10) Pub. No.: US 2026/0238942 A1
(43) Pub. Date: Aug. 13, 2026

(54) Testing Method and Testing Equipment for Air Pulse Generating Device

(71) Applicant: XMEMS TAIWAN CO., LTD., Hsinchu County (TW)

(72) Inventors: Wei-Yang Li, Hsinchu County (TW); Hao-Hsin Chang, New Taipei City (TW); Ping-Sheng Wang, Hsinchu County (TW); Yuan-Shuang Liu, Hsinchu County (TW); Wen-Chih Chen, Hsinchu County (TW); Hai-Hung Wen, Hsinchu County (TW)

(73) Assignee: XMEMS TAIWAN CO., LTD., Hsinchu County (TW)

(21) Appl. No.: 19/461,667

(22) Filed: Jan. 27, 2026

Related U.S. Application Data
(60) Provisional application No. 63/755,988, filed on Feb. 7, 2025.

(51) Int. Cl. H04R 29/00; G01H 13/00; H04R 1/02; H04R 1/08; H04R 3/04

(52) U.S. Cl. CPC H04R 29/001; G01H 13/00; H04R 1/026; H04R 3/04; H04R 1/08

(57) ABSTRACT

A testing method for testing an air-pulse generating device includes obtaining a resonant frequency of the air-pulse generating device, obtaining an optimal operating frequency of the air-pulse generating device, determining whether a relative distance between the resonant frequency and the optimal operating frequency is within a certain range, and discarding the air-pulse generating device when the relative distance is within the certain range.

### CROSS REFERENCE TO RELATED APPLICATIONS

This application claims the benefit of U.S. Provisional Application No. 63/755,988, filed on Feb. 7, 2025. The content of the application is incorporated herein by reference.

### BACKGROUND OF THE INVENTION

### 1. Field of the Invention

The present application relates to a testing method and a testing equipment, and more particularly, to a testing method and a testing equipment preventing damage.

### 2. Description of the Prior Art

In the field of air pulse generating (APG) devices, conventional sound production relies on driving the device at a specific valve driving frequency to generate air pulses and achieve a desired Sound Pressure Level (SPL). To maximize acoustic output, prior art often attempts to set the operating frequency close to the resonant frequency of the device.

However, such methodologies encounter significant limitations due to inherent manufacturing variations, where the material and mechanical design of individual units result in varying resonant frequencies rather than a uniform constant. Because these APG devices typically exhibit a high quality factor (Q) at resonance, operating too close to the device-specific poses a severe risk of structural damage or flap fatigue caused by membrane displacement exceeding design limits.

Prior art remains prone to over-driving the hardware, which ultimately compromises both long-term reliability and acoustic performance.

Therefore, there is a need to improve over prior art.

### SUMMARY OF THE INVENTION

It is therefore a primary objective of the present application to provide a testing method and a testing equipment, to improve over disadvantages of the prior art.

An embodiment of the present invention provides a testing method for testing an air-pulse generating device, comprising obtaining a resonant frequency of the air-pulse generating device; obtaining an optimal operating frequency of the air-pulse generating device; determining whether a relative distance between the resonant frequency and the optimal operating frequency is within a certain range; and discarding the air-pulse generating device when the relative distance is within the certain range.

An embodiment of the present invention provides a testing equipment, configured to perform a testing process on an air-pulse generating device, comprising an LCR (Inductance Capacitance Resistance) meter, wherein a resonant frequency of the air-pulse generating device is obtained via the LCR meter; an analyzer, such that an optimal operating frequency of the air-pulse generating device is obtained via the analyzer; and a controller, configured to determine whether a relative distance between the resonant frequency and the optimal operating frequency is within a certain range, and to discard the air-pulse generating device when the relative distance is within the certain range.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a testing process according to an embodiment of the present application.

FIG. 2 is a schematic diagram of a testing equipment according to an embodiment of the present application.

### DETAILED DESCRIPTION

The technical features described in the embodiments of the present invention may be mixed or combined in various ways as long as there are no conflicts between them.

Content of U.S. Pat. No. 11,943,585, application Ser. No. 19/035,763, application Ser. No. 19/287,761 and application Ser. No. 19/424,094 is incorporated herein by reference.

The present invention is to provide a testing method for an air pulse generating (APG) devices, to discard APG devices with optimal operating frequency being too close to the resonant frequency, where the operating frequency may be a valve driving frequency of the APG devices. Both the operating frequency and the valve driving frequency are denoted as F_{V} in the present invention.

The APG devices in the present application refer to the APG devices disclosed in U.S. Pat. No. 11,943,585 and application Ser. No. 19/035,763, where the APG device comprises a flap pair or comprises a first flap and a second flap. The flap pair performs common mode movement to form air pressure variation and performs differential mode movement to form a virtual valve or an opening at an opening rate synchronous to the valve driving frequency. Specifically, the flap pair is driven by pressure (modulation) driving signal (denoted as SM) to perform the common mode movement and is driven by valve (demodulation) driving signal (denoted as SV) to perform the differential mode movement. The pressure driving signal corresponds to a pressure driving frequency (denoted as F_{M}) and the valve driving signal corresponds to a valve driving frequency (denoted as F_{V}).

In an embodiment, the valve driving frequency may be half of the pressure driving frequency, i.e., F_{V}=½·F_{M}. In another embodiment, the valve driving frequency may be the pressure driving frequency, i.e., F_{V}=F_{M}.

In order to enhance sound pressure level (SPL), the valve driving frequency F_{V} is chosen to close to a resonant frequency Fr of the APG device, where rationale behind such choice has been elaborated in application Ser. No. 19/035,763 and application Ser. No. 19/287,761. However, if the valve driving frequency F_{V} is too close to the resonant frequency Fr, it would cause damage on the flap pair, especially when the APG device is a high-Q device with high quality factor Q.

The present invention is to discard the APG devices whose optimal operating frequency F_{V} is too close to the resonant frequency Fr during the testing process.

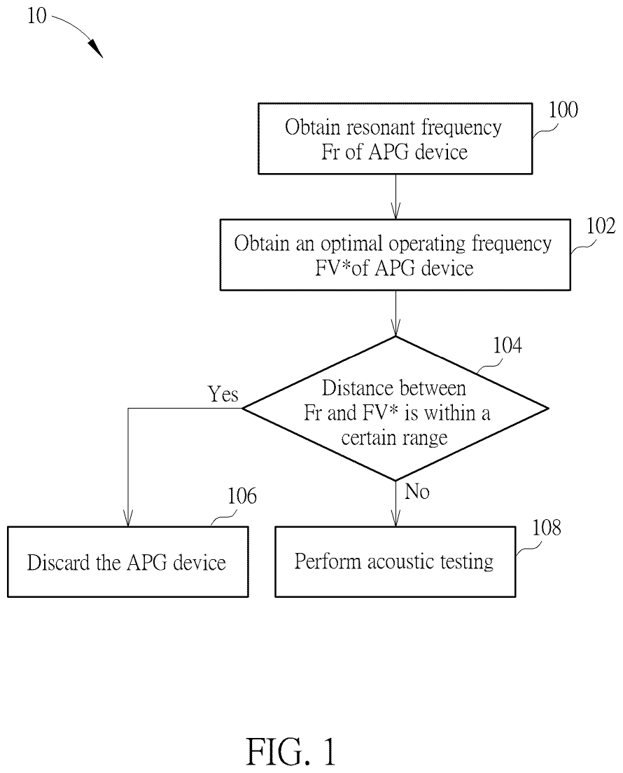

FIG. 1 is a schematic diagram of a testing process 10 according to an embodiment of the present invention. The testing process 10 may be performed by a testing equipment, e.g., a testing handler. The testing process 10 comprises the following steps:
Step 100: Obtain a resonant frequency of an APG device.
Step 102: Obtain an optimal operating frequency of the APG device.
Step 104: Determine whether a relative distance between the resonant frequency and the optimal operating frequency is within a certain range.
Step 106: Discard the APG device.
Step 108: Perform acoustic testing.

In Step 100, the resonant frequency Fr of the APG device is obtained. The APG device may be connected to an LCR meter to obtain the resonant frequency Fr of the APG device (LCR: Inductance Capacitance Resistance). The LCR meter may be a part of the testing equipment. In an embodiment, the LCR meter may obtain leakage current of the APG device.

In an embodiment, the LCR meter may sense the APG device and obtain electric inductance-capacitance-resistance of the APG device in various frequencies. In another embodiment, acoustic inductance-capacitance-resistance of the APG device in various frequencies may be obtained, which is also within the scope of the present invention.

In an embodiment, frequency sweeping of a conductance of the APG device may be performed, in order to obtain the resonant frequency Fr. The conductance may be electric or acoustic conductance.

In Step 102, an optimal operating frequency F_{V}* of the APG device is obtained. A driving circuit associated with the APG device may be included in, e.g., the testing equipment/handler.

In an embodiment, the APG device may be driven by the valve driving signals with various valve driving frequencies. A valve driving frequency having optimal or specific acoustic performance may be chosen as the optimal operating frequency F_{V}*. For example, a valve driving frequency producing a maximum or specific SPL may be chosen as the optimal operating frequency F_{V}*. That is, frequency sweeping may be performed on the APG device to obtain the optimal operating frequency F_{V}*.

In an embodiment, the APG device may be driven by the valve driving signals SV with various valve driving frequencies but with a fixed amplitude of the valve driving signal, denoted as SVpp. In other words, the driving circuit may generate (a plurality of) valve driving signals SV with various valve driving frequencies F_{V} but constant amplitude SVpp, amplitude of the valve driving signal. A valve driving signal SV producing the optimal or specific acoustic performance, e.g., largest or specific SPL, among all the plurality of valve driving signals SV generated under constant SVpp, can be found. The valve driving frequency F_{V} producing optimal or specific acoustic performance can be chosen as the optimal operating frequency F_{V}*. That is, frequency sweeping under constant amplitude SVpp may be performed on the APG device to obtain the optimal operating frequency F_{V}*.

It is known that phase φ between the pressure driving signal SM and the valve driving signal SV also determines/affects SPL produced.

In an embodiment, the APG device may be driven by the valve driving signals SV with various valve driving frequencies but with a certain phase φ between the pressure driving signal SM and the valve driving signal SV. In other words, the driving circuit may generate (a plurality of) valve driving signals SV with various valve driving frequencies F_{V} but constant phase φ between the pressure driving signal SM and the valve driving signal SV. A valve driving signal SV producing the optimal or specific acoustic performance, e.g., largest or specific SPL, among the plurality of valve driving signals SV generated under constant phase φ, can be found. The valve driving frequencies F_{V} corresponding to that valve driving signal SV producing optimal or specific acoustic performance can be chosen as the optimal operating frequency F_{V}*. That is, frequency sweeping under constant phase φ may be performed on the APG device to obtain the optimal operating frequency F_{V}*.

In an embodiment, an optimal phase φ* may be obtained.

In an embodiment, the APG device may be driven by the valve driving signals SV with various phase φ but with a constant/fixed amplitude SVpp and with a constant/fixed frequency F_{V}. In other words, the driving circuit may generate (a plurality of) valve driving signals SV with various phase φ but constant amplitude SVpp and frequency F_{V}. A valve driving signal SV producing the optimal or specific acoustic performance, e.g., largest or specific SPL, among the plurality of valve driving signals SV generated under constant amplitude SVpp and frequency F_{V}, can be found. The phase φ corresponding to that valve driving signal SV producing optimal or specific acoustic performance can be chosen as the optimal phase φ*. That is, phase sweeping under constant amplitude SVpp and frequency F_{V} may be performed on the APG device to obtain the optimal phase φ*.

In other words, phase sweeping with constant amplitude SVpp and frequency F_{V} may be performed first to obtain the optimal phase φ*. Then, frequency sweeping with constant amplitude SVpp and optimal phase φ* may be performed to obtain the optimal operating frequency F_{V}*.

In Step 104, whether the relative distance between the resonant frequency Fr and the optimal operating frequency F_{V}* is within the certain range is determined. In an embodiment, the relative distance may be associated with a log-ratio distance, but not limited thereto.

In the following discussion, F_{V} is used for simplicity and can be substituted by F_{V}* for completeness.

The log-ratio distance between Fr and F_{V} may be expressed as

$$D ( Fr , {F}_{V} ) = \vert log ( Fr ) - log ( {F}_{V} ) \vert = \vert log ( \frac{Fr}{{F}_{V}} ) \vert . \qquad ( 1 )$$

In this regard, the relative distance or the log-ratio distance between Fr and F_{V} within a certain range may be expressed as

$$D ( Fr , {F}_{V} ) = \vert log ( \frac{{F}_{r}}{{F}_{V}} ) \vert \leq {D}_{a} . \qquad ( 2 )$$

In other words, the relative distance or the log-ratio distance between Fr and F_{V} within the certain range can be expressed as

$${d}_{L B} \leq \frac{Fr}{{F}_{V}} \leq {d}_{U B} or \qquad ( 3 )$$

$${d}_{U B} \leq \frac{{F}_{V}}{{F}_{r}} \leq {d}_{L B} . \qquad ( 4 )$$

In (eq. 3) and (eq. 4), d_{LB}=10^{-Da} and d_{UB}=10+Da.

In an embodiment, the operating frequency F_{V} is no greater than the resonant frequency Fr, i.e., Fr/F_{V}≥1 or F_{V}/Fr≤1. In this case, (eq. 3) and (eq. 4) may become

$$1 \leq \frac{Fr}{{F}_{V}} \leq {d}_{U B} or \qquad ( 5 )$$

$$\frac{1}{{d}_{U B}} \leq \frac{{F}_{V}}{Fr} \leq 1. \qquad ( 6 )$$

In Step 104, it is determined whether (at least) one of eqs. (3)-(6) is true when F_{V}=F_{V}*. For example, if (eq. 5) is true when F_{V}=F_{V}*, meaning that the optimal operating frequency F_{V}* is too close to the resonant frequency Fr, then go to Step 106. In an embodiment, du may numerically be 1.05 or 1.06 for reference, but not limited thereto.

The APG device satisfying (at least one of) eqs. (2)-(6) is considered that the relative distance between Fr and F_{V}* is within the certain range and is considered as having high risk of damage.

In Step 106, the APG device satisfying (at least one of) eqs. (2)-(6) is discarded. Otherwise, in Step 108, the APG device may proceed further acoustic testing. The acoustic testing may include measuring SPL, THD (THD: total harmonic distortion), roll-off, etc., of the APG device.

In an embodiment, the APG device may perform a high volume acoustic testing and a low volume acoustic testing. In an embodiment, the high volume (acoustic) testing and the low volume (acoustic) testing may be performed under the optimal phase φ* and the optimal operating frequency F_{V}* obtained in Step 102. In an embodiment, the valve driving signal amplitude SVpp may be set as 2.4 Vpp for the low volume testing and 6 Vpp for the high volume testing (Vpp: peak-to-peak voltage), which is not limited thereto.

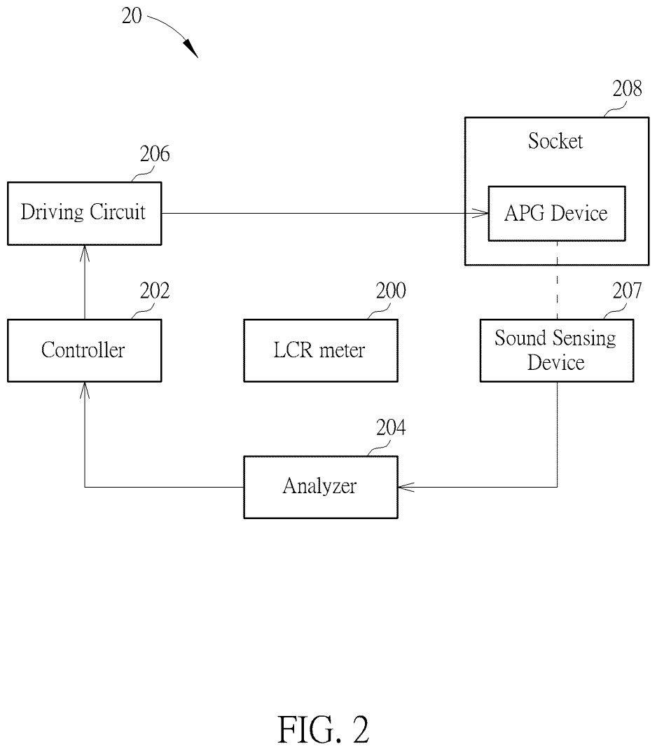

FIG. 2 is schematic diagram of a testing equipment 20 according to an embodiment of the present invention. The testing equipment 20 may be configured to perform the testing process 10. The testing equipment 20 may represent equipment for bench testing or equipment for final testing (FT). In the embodiment shown in FIG. 2, the testing equipment 20 comprises an LCR meter 200, a controller 202, an analyzer 204, a driving circuit 206, a socket 208 and a sound sensing device 207.

The controller 202 may be a computer. The analyzer 204 may be an audio analyzer or be equipment produced by Audio Precision. The driving circuit 206 may comprise circuitry disclosed in U.S. Pat. No. 12,261,567 or U.S. Pat. No. 12,107,546, which is not limited thereto. The APG device under test may be placed/disposed within the socket 208 and receive driving signals (e.g., SM and/or SV) from the driving circuit 206 during the testing process. The sound sensing device 207 may be an acoustic transducer or a microphone, configured to collect and transform acoustic wave produced by the APG device into electric signal, and the electric signal would be output to the analyzer 204 to perform acoustic analysis.

Step 100 may be performed via the LCR meter 200. Step 102 may be performed due to the driving circuit 206 generating the driving signals toward the APG device. Step 104 and Step 106 may be performed by the controller 202. Step 102 and Step 108 may be performed via the analyzer 204.

The present invention provides a testing methodology for Air Pulse Generating (APG) devices by strategically identifying and discarding units at high risk of structural damage. By evaluating the relative distance between an APG device's resonant frequency Fr and its optimal operating frequency F_{V}*, the process ensures that the valve driving frequency does not operate too close to the resonance peak. Utilizing LCR meters and acoustic analyzers to perform frequency and phase sweeping, the method effectively filters out high-Q devices prone to flap fatigue. Ultimately, this screening process guarantees that only devices with optimal acoustic performance and long-term reliability proceed to final acoustic testing.

The foregoing outlines the features of several embodiments, enabling those skilled in the art to fully appreciate the aspects of the present disclosure. Those skilled in the art should recognize that the present disclosure provides a foundation for designing or modifying other processes and structures to achieve substantially the same functions and/or substantially the same results as those of the embodiments introduced herein. Furthermore, such equivalent arrangements do not deviate from the spirit and scope of the present disclosure, and various changes, substitutions, and alterations may be made without so departing.

What is claimed is:

1. A testing method for testing an air-pulse generating device, comprising:
obtaining a resonant frequency of the air-pulse generating device;
obtaining an optimal operating frequency of the air-pulse generating device;
determining whether a relative distance between the resonant frequency and the optimal operating frequency is within a certain range; and
discarding the air-pulse generating device when the relative distance is within the certain range.

2. The testing method of claim 1, comprising:
obtaining whether a ratio of the resonant frequency to the optimal operating frequency is less than a threshold;
discarding the air-pulse generating device when the ratio of the resonant frequency to the optimal operating frequency is less than the threshold.

3. The testing method of claim 1, comprising:
obtaining whether a ratio of the optimal operating frequency to the resonant frequency is greater than a threshold;
discarding the air-pulse generating device when the ratio of the optimal operating frequency to the resonant frequency is greater than the threshold.

4. The testing method of claim 1, wherein the step of obtaining the resonant frequency comprises:
performing frequency sweeping of a conductance of the air-pulse generating device, to obtain the resonant frequency.

5. The testing method of claim 1, wherein the air-pulse generating device is driven by a pressure driving signal and a valve driving signal, the step of obtaining the optimal operating frequency comprises:
obtaining a phase between the pressure driving signal and the valve driving signal; and
obtaining the optimal operating frequency according to the phase between the pressure driving signal and the valve driving signal.

6. The testing method of claim 1,
wherein an operating frequency affects a volume of the air-pulse generating device.

7. The testing method of claim 1,
wherein the air-pulse generating device is driven according to a valve driving frequency to form a virtual valve at an opening rate synchronous to the valve driving frequency;
wherein an operating frequency is the valve driving frequency.

8. The testing method of claim 1,
wherein the opening rate is twice the valve driving frequency or the opening rate is twice of the valve driving frequency.

9. The testing method of claim 1,
wherein the air-pulse generating device comprises a flap pair.

10. A testing equipment, configured to perform a testing process on an air-pulse generating device, comprising:
an LCR (Inductance Capacitance Resistance) meter, wherein a resonant frequency of the air-pulse generating device is obtained via the LCR meter;
an analyzer, such that an optimal operating frequency of the air-pulse generating device is obtained via the analyzer; and
a controller, configured to determine whether a relative distance between the resonant frequency and the optimal operating frequency is within a certain range, and to discard the air-pulse generating device when the relative distance is within the certain range.

11. The testing equipment of claim 10, comprising:
a driving circuit, configured to drive the air-pulse generating device.

12. The testing equipment of claim 10, comprising:
a socket, wherein the air-pulse generating device is placed within the socket when performing the testing process.

13. The testing equipment of claim 10, comprising:
a sound sensing device, configured to collect and transform acoustic wave produced by the air-pulse generating device into electric signal;
wherein the electric signal is output to the analyzer.
